(19) United States
(12) Patent Application Publication
(10) Pub. No.: US 2002/0136409 A1
(43) Pub. Date: Sep. 26, 2002

(54) System and method for disabling radio frequency devices

(75) Inventor: Wayne B. Hile, Round Lake Park, IL (US)

Correspondence Address: Alistair K. Chan, FOLEY & LARDNER, Firstar Center, 777 East Wisconsin Avenue, Milwaukee, WI, 53202-5367, US

(73) Assignee: Palm, Inc.

(21) Appl. No.: 09/813,693

(22) Filed: Mar. 21, 2001

(51) Int. Cl. H04K 1/00

(52) U.S. Cl. 380/270

(57) ABSTRACT

A method and system for disabling at least a portion of at least one personal electronic device on board a vehicle is disclosed. The method and system includes sending a radio frequency signal from a transmitter on the vehicle. The method and system also includes receiving the RF signal by a receiver of the at least one personal electronic device. Further, the method and system includes interpreting the RF signal in a manner causing at least a portion of the at least one personal electronic device to be disabled.

### FIELD OF THE INVENTION

The present specification relates to the disablement of radio frequency (RF) receiving electronic devices. In particular, the specification relates to at least partially disabling personal electronic devices which may be carried on board an airplane. Further, the specification relates to the disabling of personal electronic devices which may be within a specified area.

### BACKGROUND OF THE INVENTION

Handheld computers as well as other types of personal electronic devices, for example, cellular telephones, pagers, messaging devices, laptop computers, and others, may include the use of wireless communication devices, such as Bluetooth devices, IEEE 802.11 b devices, and other RF devices. It is standard practice for commercial airlines to ask its passengers to turn off all electronic devices on board the aircraft prior to take-off. Further, the airlines also request that some devices remain off during the flight or during a portion of the flight. Of these personal electronic devices, many are enabled with RF signal generating and/or receiving devices.

Currently, it is required that the user or owner of the personal electronic device take the action of shutting down the device and ensuring that the device is in compliance with the request by the airlines. This shutting down or disabling may be accomplished in a variety of ways, for example, turning off the device, like a cell phone, for example, choosing a setting in a software menu to control and shut down only the hardware generating the RF signal. In all cases, user intervention is still required. The fact that user intervention is required leaves an opportunity for error or rejection of authority to follow the requested procedures. Further, there are instances when a personal electronic device is unintentionally allowed to remain on for any of a variety of reasons, including, but not limited to, the electronic device being left in a bag, out of sight, distractions, inability to hear the audible announcement from the airline, the belief by the user that the RF hardware was already disabled, etc.

Further, there may be other areas in which it may be desirable to cause the disablement of certain electronic devices, for example, but not limited to, laboratories in which RF generating hardware cannot be used, classrooms, lecture halls, or conference rooms where the use of personal electronic devices may be distracting, among others.

Accordingly, there is a need for a system which is configured to transmit an RF signal to personal electronic devices in and/or around a specified area. An RF signal transmitter is configured to transmit a signal which causes at least partial disablement of the personal electronic devices. Further, there is a need for a system and method for causing the at least partial disablement of personal electronic devices that are carried by users on board an airplane, prior to take-off, during final approach (landing), and during other periods in which it is requested that the personal electronic devices be at least partially disabled.

The techniques herein below extend to those embodiments which fall within the scope of the appended claims, regardless of whether they accomplish one or more of the above-mentioned needs.

### SUMMARY OF THE INVENTION

An exemplary embodiment relates to a method of disabling at least a portion of at least one personal electronic device on board a vehicle. The method includes sending a radio frequency (RF) signal from a transmitter on a vehicle. The method also includes receiving the RF signal by a receiver of at least one personal electronic device. Further, the method includes interpreting the RF signal in a manner causing at least a portion of the at least one personal electronic device to be disabled.

Another exemplary embodiment relates to a system for at least partially disabling personal electronic devices within a specified area. The system includes a transmitter configured to send a radio frequency (RF) signal, the transmitter located within the specified area. This system also includes a receiver configured to receive the RF signal. The receiver is coupled to the personal electronic device. Further, the system includes program logic configured to disable at least a portion of the personal electronic device in response to the RF signal.

Yet another exemplary embodiment relates to a method of preparing an airplane for take-off. The method includes providing a warning message to passengers relating to the disablement of personal electronic devices on board the airplane. The method also includes transmitting a radio frequency (RF) signal configured to be received by RF receivers of the personal electronic devices on board the airplane and configured to cause at least partial disablement of the personal electronic devices.

Yet still another exemplary embodiment relates to a method of preparing an area for a specific use. The method includes providing a warning message to persons in the area relating to the disablement of personal electronic devices in and near the area. The method also includes transmitting a radio frequency (RF) signal configured to be received by RF receivers of the personal electronic devices in and near the area and the RF signal is configured to cause at least partial disablement of the personal electronic devices.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an exemplary general schematic diagram of an airplane passenger cabin including a system for disabling personal electronic devices;

FIG. 2 is an exemplary schematic block diagram of a defined area including a system for disabling personal electronic devices in and/or near the defined area; and

FIG. 3 is a flow diagram depicting exemplary steps for disabling personal electronic devices in a specific area.

### DETAILED DESCRIPTION OF EXEMPLARY EMBODIMENTS

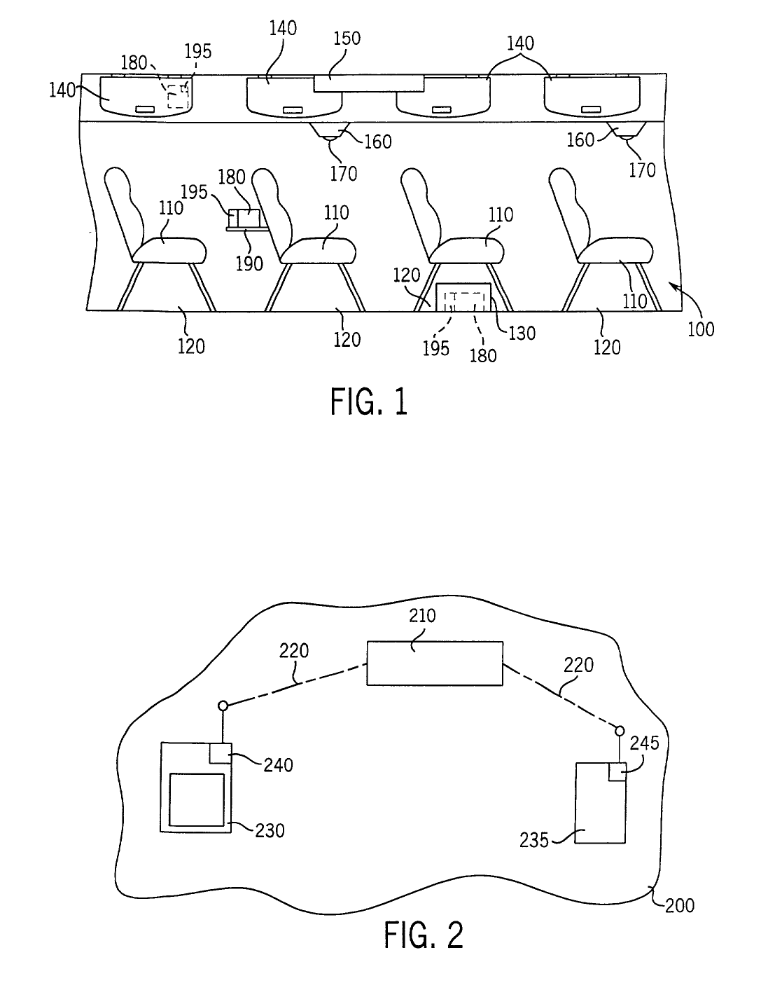

Referring to FIG. 1, an airplane passenger cabin 100 is depicted. Airline passenger cabin 100 includes a plurality of passenger seats 110 configured for seating a plurality of passengers within cabin 100. Cabin 100 further includes a stowage area 120 beneath each of seats 110 in which parcels, including, but not limited to, luggage 130 may be stowed during the airplane flight. Further, cabin 100 may include a plurality of overhead bins 140 which also may be used for stowage of luggage, and/or other parcels and personal belongings during an airplane flight.

In an exemplary embodiment, cabin 100 includes a transmitter 150. Transmitter 150 is configured to transmit radio frequency (RF) signals throughout airplane cabin 100. Further, in an exemplary embodiment cabin 100 may include information consoles 160 which may be configured with visual displays and/or audio devices such as, but not limited to, speakers 170. Consoles 160 are used to display and provide information to passengers within airplane cabin 100.

Conventionally, passengers, such as, but not limited to, business travelers, in airplane cabin 100 carry personal electronic devices 180. Personal electronic devices may include, but are not limited to, handheld computers, wireless telephones, pagers, messaging devices, notebook computers, PDAs, beepers, etc. Personal electronic devices 180 may be distributed throughout airplane cabin 100. For example, a personal electronic device 180 may be confined within luggage 130 which is in stowage 120 beneath a seat 110. Another personal electronic device may be set on a tray table 190 and may be used by a passenger seated in a seat 110; another electronic device 180 may be stowed in an overhead bin 140. Further, electronic device 180 may be found in any of a variety of other locations including, but not limited to, passenger purses, bags, pockets, coats, and further, stowed in various other locations within airplane cabin 100. In an exemplary embodiment, at least some of the personal electronic devices 180 are equipped with RF receivers, including, but not limited to, Bluetooth and 802.11 (Wi-Fi) receivers.

In preparation of a flight take-off, speaker 170 and/or a visual indicator on the display of console 160 may be used to provide an announcement to passengers in airline cabin 100 that all personal electronic devices should be shut off or disabled in a specified manner. Whether inadvertently or advertently the electronic devices are not disabled, transmitter 150 may be configured to transmit an RF signal throughout cabin 100. The RF signal is received by receivers 195 of devices 180. Devices 180 are configured to interpret the signal received from transmitter 150 as a disablement or shut-down signal and are configured to disable certain portions of the device or shut down the device all together, automatically, without user intervention. In a particular embodiment, only portions of the device, such as the RF generating hardware, may be shut down. Further, in an alternative embodiment, the device may be put into a suspend mode in which certain portions of the hardware are disabled until revived.

Further, because it is possible that passengers in airline cabin 100 may attempt to bypass the system by enabling devices 180 after they have been shut off by transmission from transmitter 150, transmissions from transmitter 150 may be repeated a plurality of times during the period in which disablement is desired, or transmitter 150 may be configured to transmit the signal continuously during the time in which disablement is desired.

In a particular exemplary embodiment, it may be desirable to encrypt transmission signals sent by transmitter 150 such that devices 180 are required to decrypt or decode the signals before interpreting the signals as shut down or disablement signals. The encryption of signals transmitted by transmitter 150 may be needed such that hackers, pranksters, and the like must have access to the encryption code in order to send a proper shut-down or disablement signal at a time which is not desired by the airline or the airplane crew. Any of a variety of standard and/or non-standard encryption methods, software, and techniques may be used.

In preparation for a flight landing, speaker 170 and/or a visual indicator on the display of console 160 may be used to provide an announcement to passengers in airline cabin 100 that all personal electronic devices should be shut off or disabled in a specified manner. Whether inadvertently or advertently the electronic devices are not disabled, transmitter 150 may be configured to transmit an RF signal throughout cabin 100. The RF signal is received by receivers 195 of devices 180. Devices 180 are configured to interpret the signal received from transmitter 150 as a disablement or shut-down signal and are configured to disable certain portions of the device or shut down the device all together, automatically, without user intervention. In a particular embodiment, only portions of the device, such as the RF generating hardware, may be shut down. Further, in an alternative embodiment, the device may be put into a suspend mode in which certain portions of the hardware are disabled until revived. In preparation for flight landing it is likely that many electronic devices have been turned on during the flight and as such many may be inadvertently left on. Accordingly, it is advantageous to utilize a transmitter 150 configured to provide a disablement signal to the electronic devices that may be left on.

Referring now to FIG. 2, a specified use area 200 is depicted. Specified use area 200 may be any of a variety of specific use areas, such as, but not limited to, conference and/or meeting rooms, classrooms, laboratories, hospitals, or any of a variety of environments, including other types of vehicles besides airplanes, in which it may be desirable to have personal electronic devices disabled, at least in some manner. Specified use area 200 includes a transmitter 210 configured to transmit RF signals 220 to a plurality of personal electronic devices 230 and 235 including receivers and/or transceivers 240 and 245, respectively. In the diagram shown, persons entering andlor near specified use area 200 and carrying devices 230 or 235 will have devices 230 or 235 at least partially disabled when transmitter 210 transmits a disablement signal throughout specified use area 200. Accordingly, devices 230 and 235 receiving signals 220 will be at least partially shut down and/or disabled.

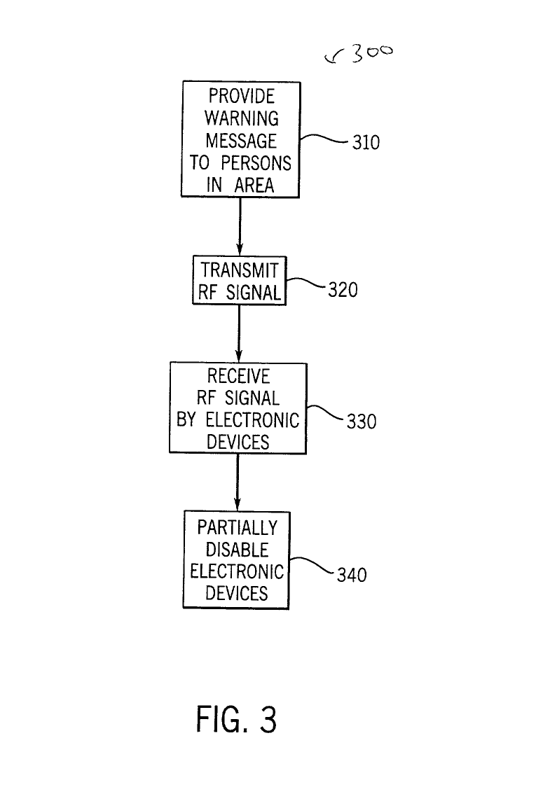

Referring now to FIG. 3, a flow diagram is shown depicting exemplary steps followed in at least partially disabling electronic devices, such as personal electronic devices. In the exemplary steps shown, a warning message is provided to persons nearing and/or entering the area in which the devices may be shut down and/or disabled (step 310). The warning message may be in any of a variety of forms, including, but not limited to, printed signs, electronic displays, lighted signs, audible messages, among others. When an electronic device is in and/or near the specified area, a transmitter may selectively transmit an RF signal throughout the area (step 320). The electronic devices in and/or near the area may include receivers which are configured to receive the RF signal (step 330) and further to interpret the signal as a disablement or shut-down signal. In an exemplary embodiment, the electronic devices will interpret the RF signal as a disablement or shutdown signal and will carry out procedures to partially disable the electronic devices automatically (step 340).

While the detailed drawings, specific examples, and particular formulations given describe exemplary embodiments, they serve the purpose of illustration only. The hardware and software configurations shown and described may differ depending on the chosen performance characteristics and physical characteristics of the communications devices and electronic devices. For example, the type of personal electronic device, encrypting techniques, and environments may differ. The systems and methods shown and described are not limited to the precise details and conditions disclosed. Furthermore, other substitutions, modifications, changes, and omissions may be made in the design, operating conditions, and arrangement of the exemplary embodiments and the steps of the exemplary embodiments without departing from the scope of the invention as expressed in the appended claims.

What is claimed is:

1. A method of disabling at least a portion of at least one personal electronic device on board a vehicle, comprising:
sending a radio frequency (RF) signal from a transmitter on the vehicle;
receiving the RF signal by a receiver of the at least one personal electronic device; and
interpreting the RF signal in a manner causing at least a portion of the at least one personal electronic device to be disabled.

2. The method of claim 1, wherein sending the radio frequency signal is carried out more than once during a use of the vehicle.

3. The method of claim 1, wherein the receiver is a Bluetooth receiver.

4. The method of claim 1, wherein the receiver is a cellular phone receiver.

5. The method of claim 1, further comprising:
encrypting the RF signal sent by the transmitter on the airplane.

6. The method of claim 5, further comprising:
decrypting the RF signal by the at least one personal electronic device.

7. The method of claim 1, further comprising:
providing an announcement relating to the disabling of personal electronic devices.

8. The method of claim 1, wherein sending the radio frequency is continued throughout the duration of a period in which the personal electronic devices are to remain at least partially disabled.

9. The method of claim 1, wherein the at least one personal electronic device includes a handheld computer including an RF receiver.

10. A system for at least partially disabling personal electronic devices within a specified area, comprising:
a transmitter configured to send a radio frequency (RF) signal, the transmitter located within the specified area;
a receiver configured to receive the RF signal, the receiver being coupled to the personal electronic device;
program logic configured to disable at least a portion of the personal electronic device in response to the RF signal.

11. The system of claim 10, further comprising:
an audio system configured to broadcast an audio warning relating to the automatic disablement of the personal electronic devices.

12. The method of claim 10, further comprising:
an encryption logic for encrypting the RF signal.

13. The method of claim 10, further comprising:
a decryption logic configured for decoding the RF signal.

14. The method of claim 10, wherein the receiver includes a Bluetooth receiver.

15. The method of claim 10, wherein the receiver includes a cellular phone receiver.

16. The method of claim 10, wherein at least one of the personal electronic devices is a handheld computer.

17. The method of claim 10, wherein at least one of the personal electronic devices is a cellular telephone.

18. The method of claim 10, wherein at least one of the personal electronic devices is a text messaging device.

19. The method of claim 10, wherein at least one of the personal electronic devices is a laptop computer.

20. A method of preparing an airplane for takeoff, the method comprising:
providing a warning message to passengers relating to the disablement of personal electronic devices on board the airplane;
transmitting a radio frequency (RF) signal configured to be received by RF receivers of the personal electronic devices on board the airplane and configured to cause at least partial disablement of the personal electronic devices.

21. The method of claim 20, wherein transmitting the RF signal is carried out more than once.

22. The method of claim 20, wherein at least on of the RF receivers is a Bluetooth receiver.

23. The method of claim 20, wherein at least one of the receivers is a cellular phone receiver.

24. The method of claim 20, further comprising:
encrypting the RF signal.

25. The method of claim 20, further comprising:
decrypting the RF signal by the at least one personal electronic device.

26. The method of claim 20, wherein transmitting the RF signal is continued throughout the duration of a period in which the personal electronic devices are to remain at least partially disabled.

27. The method of claim 20, wherein at least one of the personal electronic devices includes a handheld computer including an RF receiver.

28. A method of preparing an area for a specific use, comprising:
providing a warning message to persons in the area relating to the disablement of personal electronic devices in and near the area;
transmitting a radio frequency (RF) signal configured to be received by RF receivers of the personal electronic devices in and near the area and configured to cause at least partial disablement of the personal electronic devices.

29. The method of claim 28, wherein transmitting the RF signal is carried out more than once.

30. The method of claim 28, wherein at least on of the RF receivers is a Bluetooth receiver.

31. The method of claim 28, wherein at least one of the receivers is a cellular phone receiver.

32. The method of 28, further comprising:
encrypting the RF signal.

33. The method of claim 28, further comprising:
decrypting the RF signal by the at least one personal electronic device.

34. The method of claim 28, wherein transmitting the RF signal is continued throughout the duration of a period in which the personal electronic devices are to remain at least partially disabled.

35. The method of claim 28, wherein at least one of the personal electronic devices includes a handheld computer including an RF receiver.
